(19) United States
(12) Patent Application Publication
(10) Pub. No.: US 2025/0210285 A1
(43) Pub. Date: Jun. 26, 2025

(54) SEALING STRUCTURE AND ELECTRONIC DEVICE

(71) Applicant: Lenovo (Beijing) Limited, Beijing (CN)

(72) Inventors: Feng LI, Beijing (CN); Enling PANG, Beijing (CN); Weiwen ZHOU, Beijing (CN)

(21) Appl. No.: 19/000,655

(22) Filed: Dec. 23, 2024

(30) Foreign Application Priority Data
Dec. 26, 2023 (CN) 202311812955.2

(51) Int. Cl. H01H 9/04; H01F 7/02

(52) U.S. Cl. CPC H01H 9/04; H01F 7/021

(57) ABSTRACT

A sealing structure includes a housing, a moving member, a sealing element, and a drive assembly. The housing includes an opening. The moving member is located within a space enclosed by the housing and is capable of moving relative to the opening from a first position to a second position. The sealing element is arranged between the housing and the moving member. The drive assembly provides a first force to the moving member in a direction from the moving member to the opening at the first position and the second position to cause the sealing element to be abutted between the moving member and the housing to seal the opening.

### CROSS REFERENCE TO RELATED APPLICATION

The present disclosure claims priority to Chinese Patent Application No. 202311812955.2, filed on Dec. 26, 2023, the entire content of which is incorporated herein by reference.

### TECHNICAL FIELD

The present disclosure is related to the sealing technology field and, more particularly, to a sealing structure and an electronic device.

### BACKGROUND

Various types of electronic devices need to be provided with operable keys. For example, some keys are pressed to complete operations, and some other keys are toggled to complete operations. However, regardless of whether the keys are pressed or toggled, the keys need to be waterproof and dustproof.

In related technology, the keys that are toggled to complete the operation are normally slidingly connected in the electronic device. Since toggling the keys causes sliding relative to the housing of the electronic device, the toggle keys in a still state are difficult to be sealed, or the sealing structure is prone to failure when being frequently used.

### SUMMARY

An aspect of the present disclosure provides a sealing structure including a housing, a moving member, a sealing element, and a drive assembly. The housing includes an opening. The moving member is located within a space enclosed by the housing and is capable of moving relative to the opening from a first position to a second position. The sealing element is arranged between the housing and the moving member. The drive assembly provides a first force to the moving member in a direction from the moving member to the opening at the first position and the second position to cause the sealing element to be abutted between the moving member and the housing to seal the opening.

An aspect of the present disclosure provides an electronic device including a sealing structure and a toggle switch. The sealing structure includes a housing, a moving member, a sealing element, and a drive assembly. The housing includes an opening. The moving member is located within a space enclosed by the housing and is capable of moving relative to the opening from a first position to a second position. The sealing element is arranged between the housing and the moving member. The drive assembly provides a first force to the moving member in a direction from the moving member to the opening at the first position and the second position to cause the sealing element to be abutted between the moving member and the housing to seal the opening. The toggle switch is connected to the moving member.

### BRIEF DESCRIPTION OF THE DRAWINGS

FIG. 1 illustrates a schematic exploded diagram of a sealing structure according to some embodiments of the present disclosure.

FIG. 2 illustrates a schematic cross-sectional diagram of a sealing structure in an unstably placed state according to some embodiments of the present disclosure.

FIG. 3 illustrates a schematic cross-sectional diagram showing a moving member of a sealing structure at a first position according to some embodiments of the present disclosure.

FIG. 4 illustrates a schematic cross-sectional diagram showing a moving member of a sealing structure at a second position according to some embodiments of the present disclosure.

FIG. 5 illustrates a schematic cross-sectional diagram showing a moving member of a sealing structure at a third position according to some embodiments of the present disclosure.

### REFERENCE NUMERALS

A Direction from a first position to a second position

| | |
|---|---|
| 1 | Housing |
| 11 | Opening |
| 12 | Sliding groove |
| 2 | Moving member |
| 21 | Accommodation groove |
| 22 | Toggle member |
| 23 | Concave groove |
| 3 | Sealing element |
| 4 | Drive assembly |
| 41 | First drive member |
| 42 | Second drive member |
| 5 | Supporting frame |
| 51 | Position limiting protrusion |
| 6 | Sliding member |
| 7 | Toggle switch |
| 8 | Circuit board |

### DETAILED DESCRIPTION OF THE EMBODIMENTS

To make the objectives, technical solutions, and advantages of embodiments of the present disclosure clearer, the technical solutions of the present disclosure are described in detail in connection with the accompanying drawings of embodiments of the present disclosure. The described embodiments are used to describe the present disclosure not limiting the scope of the present disclosure.

In embodiments of the present disclosure, the terms “first” and “second” are used merely to describe the purposes and should not be understood to imply relative importance or specify the number of features indicated. Accordingly, features defined as “first” or “second” can explicitly or implicitly include one or more such features. In the description of embodiments of the present disclosure, unless otherwise stated, “a plurality of” means two or more.

In addition, in embodiments of the present disclosure, directional terms such as “up,” “down,” “left,” and “right” are defined relative to the orientation of members in the figures. The directional terms are relative concepts and can be used for relative description and explanation.

The directional terms can change according to the change in the orientation of the members in the figures.

In embodiments of the present disclosure, unless explicitly defined otherwise, the term “connection” should be interpreted broadly. For example, “connection” can include fixed connection, detachable connection, or integrated connection, or direct connection or indirect connection through including fixed, detachable, or integrated connections, and may be either direct or indirect connection through an intermediate medium.

In embodiments of the present disclosure, the terms “including,” “comprising,” and any other variations are intended to encompass non-exclusive inclusions. Thus, a process, method, item, or apparatus that includes a series of elements not only includes those elements but also includes other elements that are not explicitly listed or elements inherent to such a process, method, item, or apparatus. When there are no more limitations, the element defined by “include a . . . ” does not exclude the presence of other similar elements within the process, method, item, or apparatus.

In embodiments of the present disclosure, the term “exemplary” or “for example” is used to indicate examples, embodiments, or descriptions. Any embodiment or design solution described as “exemplary” or “for example” in embodiments of the present disclosure should not be preferred or advantageous over other embodiments. The term “exemplary” or “for example” is merely used to present relevant concepts.

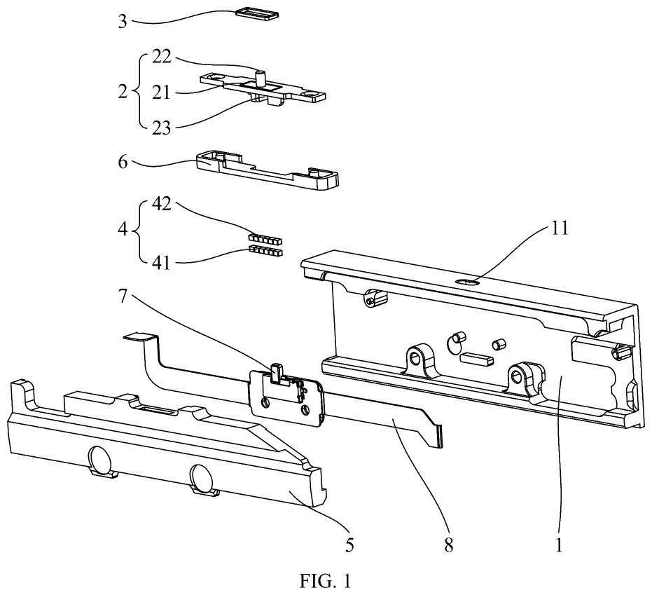

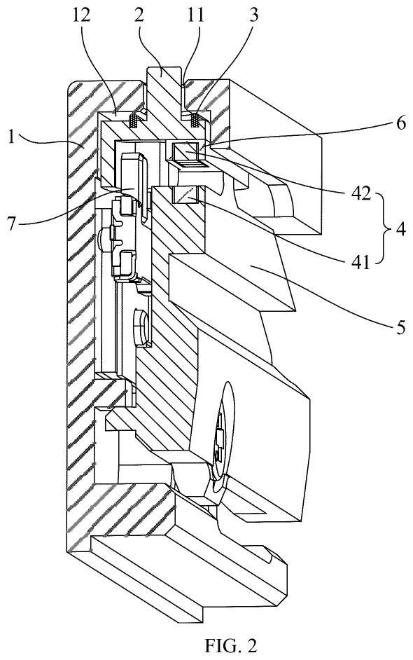

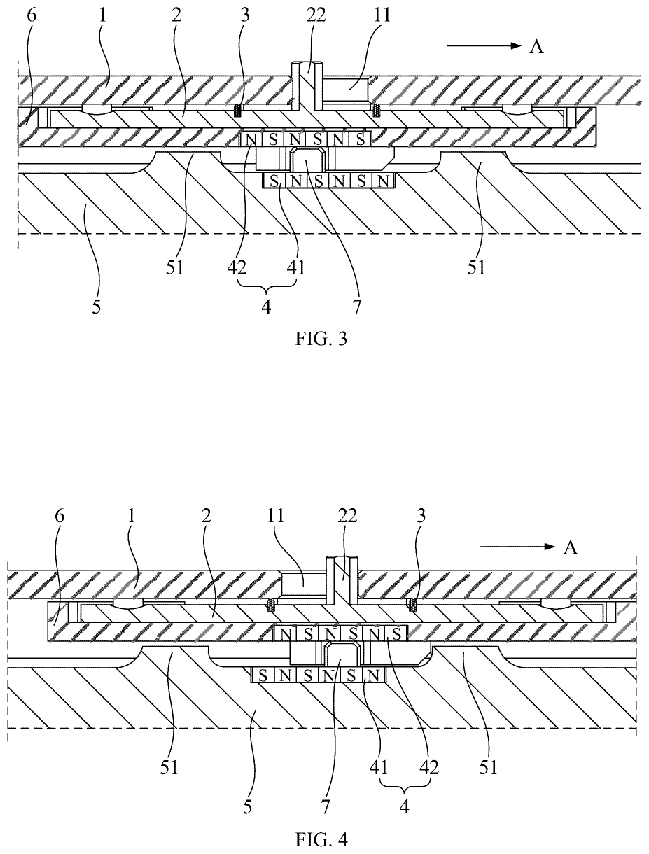

Embodiments of the present disclosure provide a sealing structure. FIG. 1 illustrates a schematic exploded diagram of the sealing structure according to some embodiments of the present disclosure. FIG. 2 illustrates a schematic cross-sectional diagram of the sealing structure in an unstably placed state according to some embodiments of the present disclosure. FIG. 3 illustrates a schematic cross-sectional diagram showing a moving member of the sealing structure at a first position according to some embodiments of the present disclosure. FIG. 4 illustrates a schematic cross-sectional diagram showing the moving member of the sealing structure at a second position according to some embodiments of the present disclosure. The sealing structure can be applied to various devices, such as laptops, desktops, tablets, servers, exchangers, routers, cell phones, or vehicles. With the sealing structure, a structural member that needs to move relatively can be well and effectively sealed for a long time.

In embodiments of the present disclosure, the sealing structure can include a housing 1, a moving member 2, a sealing element 3, and a drive assembly 4. The housing 1 can include an opening 11. The moving member 2 can be located in the space enclosed by the housing 1 and can move from a first position to a second position relative to the opening 11. The sealing element 3 can be arranged between the housing 1 and the moving member 2. At the first position and the second position, the drive assembly 4 can provide a first force to the moving member 2 in a direction from the moving member 2 toward the opening 11 to cause the sealing element 3 to abut against between the moving member 2 and the housing 1 to seal the opening 11.

In embodiments of the present disclosure, the housing 1 can be a structural member configured to carry and mount other parts. For example, the housing 1 can include an accommodation chamber. The opening 11 can be formed at the housing 1 to allow other parts to extend outside of the housing 1 from inside of the housing 1 through the opening 11. For example, the opening 11 can be an annular through-hole integrally formed and closed. For another example, the housing 11 can include two portions connected to each other. The opening 11 can also be a through-hole formed by unclosed gaps on the edges of the two portions of the housing 1. The structure of the housing 1 can be configured according to the application scenarios of the sealing structure. Embodiments of the present disclosure do not limit the structure of the housing 1.

In embodiments of the present disclosure, as shown in FIG. 2, the moving member 2 is positioned inside the housing 1 and located at the position of the opening 11 of the housing 1. A portion of the moving member 2 can extend through the opening 11 to the outside of the housing 1, or a portion of the moving member 2 can be aligned with the opening 11. As shown in FIGS. 3 and 4, the moving member 2 moves relative to the opening 11 of the housing 1. That is, the moving member 2 can move from the first position to the second position relative to the opening 11. For example, the moving member 2 can move from one side of the opening 11 to the other side of the opening 11.

In embodiments of the present disclosure, the sealing element 3 can be configured to seal the opening 11 of the housing 1. The sealing element 3 can be arranged between the housing 1 and the moving member 2. For example, the sealing element 3 can be configured as an annular sealing ring. The sealing ring can be arranged around the opening 11 between the housing 1 and the moving member 2. The sealing element 3 can be made of materials such as rubber, silicone, or plastic.

In embodiments of the present disclosure, a drive assembly 4 can be arranged at the housing 1 and the moving member 2. The drive assembly 4 can apply a first force to the moving member 2 in the direction from the moving member 2 toward the opening 11 of the housing 1. Under the first force, the moving member 2 can move along a direction to approach the opening 11 of the housing 1. For example, when the drive assembly 4 is arranged at the first position and the second position, the drive assembly 4 can apply the first force to the moving member 2. When the moving member 2 is at the first position and the second position relative to the opening 11, the moving member 2 can abut against the sealing element 3. Since the sealing element 3 also abuts against the housing 1, the sealing element 3 can be configured to seal the opening 11 of the housing 1.

In sealing structure of embodiments of the present disclosure, since the housing 1 includes the opening 11, and the moving member 2 is arranged in the housing 1, the moving member 2 can be operated through the opening 11. A sealing element 3 can be arranged between the housing 1 and the moving member 2. The sealing element 3 can be configured to seal the opening 11 of the housing 1 to improve the waterproofing and dustproofing functionality for the sealing structure. Meanwhile, the drive assembly 4 can be arranged in the sealing structure. When the moving member 2 is at the first position or the second position relative to the opening 11, the drive assembly 4 can apply the first force to the moving member 2. Under the first force, the moving member 2 can abut tightly against the sealing element 3 between the moving member 2 and the housing 1 to seal the opening 11 of the housing 1 well, which improves the reliability of the sealing structure. When the moving member 2 moves from the first position to the second position or from the second position to the first position, the drive assembly 4 may not provide the first force to the moving member 2, or the force applied by the user to the moving member 2 can be greater than the first force to separate the sealing element 3 and the housing 1 or separate the sealing element 3 and the moving member 2. Thus, the sliding friction of the sealing element 3 can be reduced, which can reduce the wear of the sealing element 3 to improve the service life of the sealing element 3. Thus, with the sealing structure of embodiments of the present disclosure, the sealing reliability and the service life of the sealing mechanism can be improved.

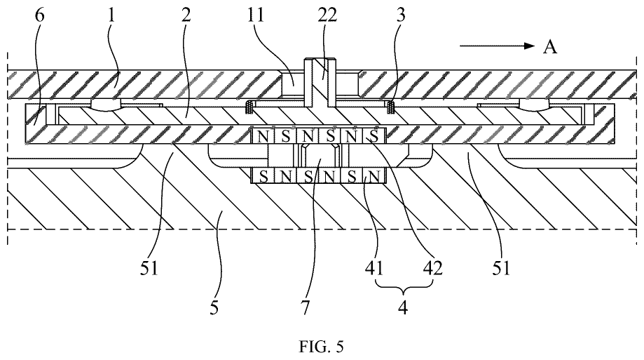

In some embodiments, FIG. 5 illustrates a schematic cross-sectional diagram showing the moving member of the sealing structure at a third position according to some embodiments of the present disclosure. The moving member 2 can move relative to the opening 11 from the first position passing the third position to reach the second position. At the third position, the drive assembly 4 can provide a second force having a direction opposite to the direction of the first force to the moving member 2, or a third force to the moving member 2 smaller than the first force when the moving member 2 is at the first position. Thus, the force causing the sealing element 3 to be abutted between the moving member 2 and the housing 1 can be reduced.

In embodiments of the present disclosure, as shown in FIG. 5, when the moving member 5 moves from the first position to the second position relative to the opening 11, the position of the moving member 2 when moving relative to the opening 11 is the third position. In some other embodiments, the third position can be a position of the moving member 2 between the first position and the second position relative to the opening 11.

For example, the drive assembly 4 can be configured to provide the second force to the moving member 2 when the moving member 2 is at the third position relative to the opening 11. The direction of the second force can be opposite to the direction of the first force. That is, the drive assembly 4 can provide the second force to the moving member 2 in the direction from the opening 11 toward the moving member 2. The amplitude of the second force can be the same as or close to the amplitude of the first force.

In some other embodiments, the drive assembly 4 can also be configured to provide the third force to the moving member 2 when the moving member 2 is at the third position relative to the opening 11. The direction of the third force can be the same as the direction of the first force. That is, the drive assembly 4 can still provide the third force to the moving member 2 in the direction from the moving member 2 toward the opening 11. However, the amplitude of the third force can be smaller than the amplitude of the first force. For example, the amplitude of the third force can be two thirds, half, one third, or one fourth of the amplitude of the first force. The amplitude of the third force can be close to zero. That is, at the third position, the amplitude of the force provided by the drive assembly 4 to the moving member 2 can be ignored compared to the weight or the friction of the moving member 2.

Based on the above, when the drive assembly 4 is arranged at the third position, the drive assembly 4 can provide the second force or the third force to the moving member 2. Thus, when the moving member 2 is at the third position, the second force can cause the moving member 2 to move in the direction away from the opening 11 to separate the sealing element 3 and the moving member 2 or the housing 1. Thus, the sliding friction of the sealing element 3 can be reduced, or the friction of the sealing element 3 can be reduced through the third force to reduce the wear of the sealing element 3 due to the friction. Therefore, the service life of the sealing element 3 can be extended.

In embodiments of the present disclosure, as shown in FIG. 1, the moving member 2 includes an accommodation groove 21 on a side of the moving member 2 facing the opening 11. The sealing element 3 is fixed in the accommodation groove 21. The sealing element 3 can move with the moving member 2 together relative to the opening 11.

In embodiments of the present disclosure, the moving member 2 can include a structure configured to mount the sealing element 3 to fixedly mount the sealing element 3 at the moving member 2.

For example, the accommodation groove 21 can be formed on the side of the moving member 2 facing the opening 11 of the housing 1 to cooperate with the sealing element 3. For example, an annular concave groove can be formed at the moving member 2. The sealing element 3 can be fixed in the concave groove in a glued manner or a snapped manner. The sealing element 3 can move with the moving member 2 together between the first position and the second position relative to the opening 11.

In some embodiments, since the accommodation groove 21 is formed on the side of the moving member 2 facing the opening 11, the sealing element 3 can be fixedly mounted in the accommodation groove 21. Thus, the sealing element 3 and the moving member 2 can be sealedly connected to cause the sealing element 3 to abut against the edge of the opening 11 of the housing 1.

In some embodiments, the drive assembly 4 can include a first drive member 41 and a second drive member 42. The first drive member 41 can be mounted at the housing 1, and the second drive member 42 can be mounted at the moving member 2. The first drive member 41 and the second drive member 42 can interact with each other to generate a force.

In some embodiments, to cause the drive assembly 4 to provide a force to the moving member 2, the drive assembly 4 can include the first drive member 41 and the second drive member 42. The first drive member 41 and the second drive member 42 can interact with each other to generate the force.

For example, as shown in FIG. 2, the first drive member 41 is mounted at the housing 1. If the first drive member 41 is mounted at a position of the housing 1 on a side of the moving member 2 away from the opening 11. Correspondingly, the second drive member 42 can be mounted on the side of the moving member 2 away from the opening 11 of the housing 1. Thus, at the first position and the second position, the first drive member 41 can generate a force to the second drive member 42. The second drive member 42 can drive the moving member 2 to move in a direction toward the opening 11. At the third position, the first drive member 41 can generate a pull force to the second drive member 42. The second drive member 42 can drive the moving member 2 to move in a direction away from the opening 11. In some other embodiments, the force generated by the first drive member 41 to the second drive member 42 can be reduced or may not generated.

For another example, the first drive member 41 can also be mounted at a position of the housing 1 neighboring to the opening 11. Correspondingly, the second drive member 42 can be mounted on a side of the moving member 2 close to the opening 11 of the housing 1. Thus, at the first position and the second position, the first drive member 41 can generate a pull force to the second drive member 42. The second drive member 42 can drive the moving member 2 to move in a direction toward the opening 11. At the third position, the first drive member 41 can generate a push force to the second drive member 42. The second drive member 42 can drive the moving member 2 to move in the direction away from the opening 11, or the force generated by the first drive member 41 to the second drive member 42 can be reduced or not generated.

Based on the above, since the drive assembly 4 includes the first drive member 41 and the second drive member 42, the first drive member 41 and the second drive member 42 can be mounted at the housing 1 and the moving member 2, respectively. Thus, the force generated between the first drive member 41 and the second drive member 42 can cause the second drive member 42 to drive the moving member 2 to move in a direction to approach the opening 11 or away from the opening 11 can create a force to drive the moving member 2 in a direction toward or away from the opening 11.

In embodiments of the present disclosure, the first drive member 41 can include a plurality of first permanent magnets, and/or the second drive member 42 can include a plurality of second permanent magnets. In the moving direction of the moving member 2 relative to the opening 11, the plurality of first permanent magnets can be arranged in sequence, and the plurality of second permanent magnets can be arranged in sequence. At the first position and the second position, the second permanent magnets and the first permanent magnets can generate a first force. At the third position, the second permanent magnets and the first permanent magnets can generate a second force, or the third force generated by the second permanent magnets and the first permanent magnets can be smaller than the first force generated at the first position.

In embodiments of the present disclosure, the first drive member 41 and the second drive member 42 can be made of permanent magnets. The plurality of permanent magnets can be mounted at the housing 1 and the moving member 2. The magnetic force between the permanent magnets can cause the moving member 2 to move in the direction toward or away from the opening 11.

For example, as shown in FIG. 3, the first drive member 41 includes the plurality of first permanent magnets. The plurality of first permanent magnets are arranged in sequence in the moving direction of the moving member 2 relative to the opening 11. Correspondingly, the second drive member 42 includes the plurality of second permanent magnets. Similarly, the plurality of second permanent magnets can be arranged in sequence in the moving direction of the moving member 2 relative to the opening 11. For example, the plurality of first permanent magnets can be fixed at a position of the housing 1 on a side of the moving member 2 away from the opening 11. The plurality of second permanent magnets can be fixed on a side of the moving member 2 away from the opening of the housing 1. Ends of the plurality of first permanent magnets facing the plurality of second permanent magnets can be set to different polarities, and ends of the plurality of second permanent magnets can be set to different polarities.

Thus, when the moving member 2 is at the first position and the second position, the plurality of first permanent magnets can generate the first force to the plurality of second permanent magnets. When the moving member 2 drives the plurality of second permanent magnets to move from the first position to the second position, i.e., at the third position, the plurality of first permanent magnets can generate the second force to the plurality of second permanent magnets, or the plurality of first permanent magnets can generate the third force to the plurality of second permanent magnets.

For another example, the first drive member 41 can include a first permanent magnet, and the second drive member 42 can include a plurality of second permanent magnets. The plurality of second permanent magnets can be arranged in sequence along the moving direction of the moving member 2 relative to the opening 11. For example, the first permanent magnet can be fixed at the position of the housing 1 on the side of the moving member 2 away from the opening 11. The plurality of second permanent magnets can be mounted on the side of the moving member away from the opening 11 of the housing 1. The ends of the plurality of second permanent magnets facing the first permanent magnet can be set to different polarities.

Thus, when the moving member 2 is at the first position and the second position, the first permanent magnet can generate the first force to some second permanent magnets of the plurality of second permanent magnets. When the moving member 2 drives the plurality of second permanent magnets to move from the first position to the second position, i.e., at the third position, the first permanent magnet can generate the second force to some other second permanent magnets of the plurality of second permanent magnets, or the first permanent magnet can generate the third force to some other second permanent magnets of the plurality of second permanent magnets.

For another example, the first drive member 41 can include the plurality of first permanent magnets, and the second drive member 42 can include a second permanent magnet. The plurality of first permanent magnets can be arranged in sequence along the moving direction of the moving member 2 relative to the opening 11. For example, the plurality of permanent magnets can be mounted at the position of the housing 1 on the side of the moving member 2 away from the opening 11. The second permanent magnet can be fixed on the side of the moving member 2 away from the opening 11 of the housing 1. The ends of the plurality of first permanent magnets facing the second permanent magnet can be set to different polarities.

Thus, when the moving member 2 is at the first position and the second position, some first permanent magnets of the plurality of first permanent magnets can generate the first forces to the second permanent magnet. When the moving member 2 drives the second permanent magnet to move from the first position to the second position, i.e., at the third position, some other first permanent magnets of the plurality of first permanent magnets can generate the second forces to the second permanent magnet or generate the third forces to the second permanent magnet.

Based on the above, since the first drive member 41 and the second drive member 42 include the first permanent magnet and the second permanent magnet, respectively, by setting the numbers, polarities, and mounting positions of the first permanent magnets and the second permanent magnets, the first permanent magnets and the second permanent magnets can generate the first forces at the first position and the second position and the second position or the third position at the third position to facilitate the setting of the drive assembly 4.

In embodiments of the present disclosure, the first permanent magnets and the second permanent magnets can be configured so that the first forces generated by the second permanent magnets and the first permanent magnets are repulsive, and at the third position, the second forces generated by the second permanent magnets and the first permanent magnets can be attractive, or the repulsive force of the third force generated by the second permanent magnets and the first permanent magnets can be smaller than the repulsive force of the first forces generated at the first position.

In embodiments of the present disclosure, as shown in FIG. 3, the first drive member 41 can include six first permanent magnets, and the second drive member 42 can include six second permanent magnets. The six first permanent magnets are mounted at the position of the housing 1 on the side of the moving member 2 away from the opening 11. The six second permanent magnets are mounted on the side of the moving member 2 away from the opening 11.

For example, in direction A from the first position to the second position, the polarities of the ends of the six first permanent magnets facing the second permanent magnets can include South, North, South, North, South, and North in sequence. The polarities of the ends of the six second permanent magnets facing the first permanent magnets can include North, South, North, South, North, and South in sequence. As shown in FIG. 3, at the first position, in direction A from the first position to the second position, the second permanent magnet of the six second permanent magnets is directly opposite to the first permanent magnet of the six first permanent magnets. Thus, at the first position, five first permanent magnets of the six first permanent magnets is directly opposite to five second permanent magnets of the six second permanent magnets with the same polarities. Thus, the first permanent magnets can generate the repulsive forces to the second permanent magnets.

As shown in FIG. 4, at the second position, in direction A from the first position to the second position, the first second permanent magnet of the six second permanent magnets is directly opposite to the second first permanent magnet of the six first permanent magnets. Thus, at the second position, five of the six first permanent magnets are directly opposite to five second permanent magnets of the six second permanent magnets having the same polarities. Then, the first permanent magnets can generate the repulsive forces to the second permanent magnets.

In addition, as shown in FIG. 5, at the third position, in direction A from the first position to the second position, the six first permanent magnets are directly opposite to the six second permanent magnets. Thus, at the third position, the six first permanent magnets are directly opposite to the six second permanent magnets having different polarities, respectively. Thus, the first permanent magnets can generate attractive forces for the second permanent magnets.

For another example, the first drive member 41 can include three first permanent magnets, and the second drive member 42 can include a second permanent magnet. In direction A from the first position to the second position, the polarities of ends of the three first permanent magnets facing the second permanent magnet can include North, North (weaker magnet), and North in sequence, respectively. The polarity of the second permanent magnet facing the first permanent magnets can be North. Moreover, the magnet performance of the first permanent magnet in the middle of the three first permanent magnets can be weaker than the magnet performance of the first permanent magnets on two sides. At the first position, in direction A from the first position to the second position, the second permanent magnet can be directly opposite to the first of the three first permanent magnets.

Thus, at the first position, the second permanent magnet can be directly opposite to the first of the three first permanent magnets. Then, the first permanent magnet can generate a repulsive force to the second permanent magnet. At the third position, the second permanent magnet can be directly opposite to the first permanent magnet of the three permanent magnets in the middle. Since the magnetic performance of the first permanent magnet in the middle is weaker than the magnetic performance of the first permanent magnets on the two sides, the repulsive force of the first permanent magnet to the second permanent magnet can be reduced compared to the first position. At the second position, the second permanent magnet can be directly opposite to the third first permanent magnet of the three first permanent magnets, and the first permanent magnet can generate a repulsive force to the second permanent magnet.

For another example, the first drive member 41 can include two first permanent magnets, and the second drive member 42 can include a second permanent magnet. In direction A from the first position to the second position, the polarities of ends of the first permanent magnets facing the second permanent magnet can be North and North. The polarity of the end of the second permanent magnet facing the first permanent magnets can be North. A gap can exist between two first permanent magnets. The width of the gap can be determined according to the length of the moving member 2 relative to the opening at the third position. At the first position, in direction A from the first position to the second position, the second permanent magnet can be directly opposite to a first permanent magnet of the two first permanent magnets.

Thus, at the first position, the second permanent magnet can be directly opposite to the first of the two first permanent magnets. Then, the first permanent magnet can generate the repulsive force to the second permanent magnet. At the third position, the second permanent magnet can be directly opposite to the gap between the two first permanent magnets. Then, the second permanent magnet may not be subject to a magnetic force. At the second position, the second permanent magnet can be directly opposite to the other first permanent magnet of the two first permanent magnets, and the first permanent magnet can generate the repulsive force on the second permanent magnet.

Based on the above, since the first permanent magnets and the second permanent magnet are configured to generate the repulsive forces at the first position and the second position, the repulsive force received by the second permanent magnet can be used to drive to the moving member to move in the direction toward the opening 11 to drive the sealing element 3 to abut against the housing 1 to seal the opening 11 of the housing 1. When the first permanent magnets and the second permanent magnet can be arranged at the third position, the first permanent magnets can generate the attractive force with the second permanent magnet. The attractive force received by the second permanent magnet can be used to drive the moving member 2 to move in the direction away from the opening 11 to separate the sealing element 3 and the housing 1. In some other embodiments, at the third position, the first permanent magnets and the second permanent magnet can be configured to generate the repulsive force smaller than the repulsive force at the first position to reduce the abutting force between the sealing element 3 and the housing 1 to reduce the friction of the sealing element 3.

In embodiments of the present disclosure, the number of the first permanent magnets and the number of the second permanent magnets can be at least two. In the moving direction of the moving member 2 relative to the opening 11, the width of the first permanent magnet and the width of the second permanent magnet can be the same, and the width of the first permanent magnet can be one third of the moving distance of the moving member 2 relative to the opening 11.

In embodiments of the present disclosure, at least two first permanent magnets and at least two second permanent magnets can be provided. In the moving direction of the moving member 2 relative to the opening 11, the width of each first permanent magnet can be set to be same as the width of each second permanent magnet. Moreover, the width of the first permanent magnet can be set to be equal to or close to one third of the moving distance of the moving member 2 relative to the housing 1.

For example, two first permanent magnets can be provided, and two second permanent magnets can be provided. In direction A from the first position to the second position, the polarities of ends of the two first permanent magnets facing the second permanent magnets can include North and South. The polarities of ends of the two second permanent magnets facing the first permanent magnets can include South and North.

Thus, at the first position, in direction A from the first position to the second position, the second of the two second permanent magnets can be directly opposite to the first of the two first permanent magnets. At the second position, the first second permanent magnet of the two second permanent magnets can face be directly opposite the second first permanent magnet of the two first permanent magnets. Thus, at the first position and the second position, the first permanent magnet of the two first permanent magnets can be directly opposite to the second permanent magnet of the two second permanent magnets having the same polarity. Then, the first permanent magnet can generate the repulsive force to the second permanent magnet. At the third position, the two first permanent magnets can be directly opposite to the two second permanent magnets, respectively, and the first permanent magnets can generate the attractive force to the second permanent magnets.

For example, three first permanent magnets and three second permanent magnets can be provided. In direction A from the first position to the second position, the polarities of the ends of the three first permanent magnets facing the second permanent magnets can include North, South, and North in sequence. The polarities of the ends of the three second permanent magnets can include South, North, and South in sequence.

Thus, at the first position, in direction A from the first position to the second position, the second of the three second permanent magnets can be directly opposite to the first of the three first permanent magnets. At the second position, the first second permanent magnet of the three second permanent magnets can be directly opposite to the second first permanent magnet of the three first permanent magnets. Then, at the first position and the second position, two first permanent magnets of the three first permanent magnets can be directly opposite to two second permanent magnets of the three second permanent magnets having the same polarities, respectively. Then, the first permanent magnets can generate the repulsive force to the second permanent magnets. At the third position, the three first permanent magnets can be directly opposite to the three second permanent magnets, respectively, the first permanent magnets can generate the attractive force to the second permanent magnets.

For another example, five first permanent magnets and five second permanent magnets can be provided. In direction A from the first position to the second position, the polarities of ends of the five first permanent magnets facing the second permanent magnets can include North, South, North, South, and North in sequence. The polarities of ends of the five second permanent magnets facing the first permanent magnets can include South, North, South, North, and South in sequence.

Thus, at the first position, in direction A from the first position to the second position, the second of the five second permanent magnets can be directly opposite to the first of the five first permanent magnets. At the second position, the first second permanent magnet of the five second permanent magnets can be directly opposite to the second first permanent magnet of the five first permanent magnets. Thus, at the first position and the second position, the fourth first permanent magnet of the five first permanent magnets can be directly opposite to the fifth second permanent magnet of the five second permanent magnets having the same polarity, and the first permanent magnet can generate the repulsive force to the second permanent magnet. At the third position, the five first permanent magnets can be directly opposite to the five second permanent magnets, and the first permanent magnets can generate the attractive force to the second permanent magnets.

Based on the above, since at least two first permanent magnets and at least two second permanent magnets are provided, the width of each first permanent magnet and the width of each second permanent magnet can be set to be one third of the moving distance of the moving member 2 relative to the opening 11. Thus, by setting the positions and polarities of the at least two first permanent magnets and the at least two second permanent magnets, the first permanent magnets and the second permanent magnets can generate the repulsive forces at the first position and the second position and generate the attractive force at the third position.

In embodiments of the present disclosure, as shown in FIG. 1 and FIG. 2, the sealing structure further includes a support frame 5 fixedly connected to the housing 1. An installation space is formed between the support frame 5 and the housing 1. The moving member 2 is mounted in the installation space. The first drive member 41 is fixed at the support frame 5.

In embodiments of the present disclosure, to facilitate the installation of the first drive member 41 and other structures, the support frame 5 can be arranged in the sealing structure. For example, the support frame 5 can be fixedly mounted at a position of the housing 1 with a distance to the opening 11. Then, the installation space can be formed between the support frame 5 and the portion of the housing 1 having the opening 11. Thus, the moving member 2 can be mounted in the installation space.

For example, as shown in FIG. 3, an installation station is arranged on a side of the support frame 5 close to the moving member 2 to cooperate with the first drive member 41. The first drive member 41 can be fixedly mounted at the support frame 5 through the installation station to mount the first drive member 41 at the housing 1.

For another example, as shown in FIG. 3, a position limiting protrusion 51 is formed on the side of the support frame 5 close to the moving member 2. The position limiting protrusion 51 extends along a direction from the support frame 5 to the moving member 2. Thus, in a direction perpendicular to direction A from the first position to the second position, the position limiting protrusion 51 can limit the moving distance of the moving member 2 away from the opening 11. The contact area between the moving member 2 and the support frame 5 can be reduced by the position limiting protrusion 51, which is beneficial to reduce the wear of the moving member 2 in the movement relative to the opening 11.

Based on the above, since the support frame 5 is arranged in the sealing structure, the first drive member 41 can be easily mounted at the housing 1 through the support frame 5.

In embodiments of the present disclosure, as shown in FIG. 1 and FIG. 3, the sealing structure includes a sliding member 6 and a sliding groove 12 at the housing 1 cooperating with the sliding member 6. The sliding member 6 is slidingly mounted in the sliding groove 12. The moving member 2 is fixed on a side of the moving member 6 close to the opening 11. The second drive member 42 is fixed on a side of the sliding member 6 away from the opening 11.

In embodiments of the present disclosure, to reduce the wear between the moving member 2 and the housing 1, the sliding member 6 can be arranged in the sealing structure to fix the moving member 2 at the sliding member 6. The sliding member 6 can be slidingly connected to the housing 1.

For example, the sliding groove 12 can be arranged at the housing 1. The sliding groove 12 can cooperate with the sliding member 6 and extend in direction A from the first position to the second position. The sliding member 6 can be slidingly mounted in the sliding groove 12 to limit the moving path of the sliding member 6 relative to the housing 1. The moving member 2 can be fixedly mounted on a side of the sliding member 6 close to the opening 11 to limit the moving direction of the moving member 2 relative to the opening 11. In addition, the installation station can be arranged on a side of the sliding member 6 away from the opening 11 cooperating with the second drive member 42. Thus, the second drive member 42 can be fixedly mounted at the sliding member 6 to mount the second drive member 42 at the moving member 2.

Based on the above, since the sliding member 6 is arranged in the sealing structure, the moving member 2 can be fixedly connected to the sliding member 6. The sliding member 6 can be slidingly connected to the sliding groove 12 at the housing 1 to limit the moving path of the moving member 2 relative to the opening 11. The sliding member 6 can provide the installation station to the second drive member 42 to mount the second drive member 42 at the sliding member 6.

Meanwhile, embodiments of the present disclosure further provide an electronic device. As shown in FIG. 1 and FIG. 3, the electronic device includes the sealing structure and the toggle switch 7 above. The toggle switch 7 is connected to the moving member 2.

In embodiments of the present disclosure, as shown in FIG. 1, the toggle switch 7 is a single-pole switch configured to connect or disconnect the control circuit connected to the circuit board 8. By toggling the toggle key of the single-pole switch, the on/off of the circuit can be controlled.

In embodiments of the present disclosure, a toggle member 22 can be arranged at the moving member 2. For example, the toggle member 22 can be configured as a toggle pillar cooperating with the opening 11 of the housing 1. Thus, the toggle pillar can be arranged in the opening 11 and can extend to the outside of the housing 1 through the opening 11. A concave groove 23 can be formed on a side of the moving member 2 away from the opening 11. The concave groove 23 can be configured to cooperate with the toggle key of the single-pole switch. Thus, the toggle key can be in the concave groove 23. When the toggle pillar of the moving member 2 is toggled, the single-pole switch can be driven to connect or disconnect the circuit.

In the electronic device of embodiments of the present disclosure, since the electronic device includes the sealing structure above, the sealing reliability of the toggle switch 7 can be improved, and the service life of the sealing mechanism can be improved.

The above are merely some embodiments of the present disclosure and do not limit the scope of the present disclosure. Any modification made to equivalent structures or equivalent processes in the specification and accompanying drawings of the present disclosure can be directly or indirectly applied in the related technology field and can include the scope of the present disclosure. Especially, as long as there is no structural conflicts, the technical features of embodiments of the present disclosure can be combined in any manner. The present disclosure is not limited to the embodiments in the specification. Any equivalent modifications made based on the specification and accompanying drawings of the present disclosure can be directly or indirectly applied to other related technical fields and within the scope of the present disclosure.

What is claimed is:

1. A sealing structure comprising:
a housing including an opening;
a moving member located within a space enclosed by the housing and being capable of moving relative to the opening from a first position to a second position;
a sealing element arranged between the housing and the moving member; and
a drive assembly providing a first force to the moving member in a direction from the moving member to the opening at the first position and the second position to cause the sealing element to be abutted between the moving member and the housing to seal the opening.

2. The sealing structure according to claim 1, wherein:
the moving member moves from the first position to the second position via a third position relative to the opening; and
at the third position, the drive assembly provides a second force having a direction opposite to the first force or a third force smaller than the first force when the moving member is at the first position to the moving member to cause a force of abutting the sealing element between the moving member and the housing to be reduced.

3. The sealing structure according to claim 2, wherein:
an accommodation groove is formed on a side of the moving member facing the opening;
the sealing element is fixed in the accommodation groove; and
the sealing element moves with the moving member together relative to the opening.

4. The sealing structure according to claim 2, wherein the drive assembly includes:
a first drive member mounted at the housing; and
a second drive member mounted at the moving member, the first drive member and the second drive member interact to generate a force.

5. The sealing structure according to claim 4, wherein:
the first drive member includes a plurality of first permanent magnets, and/or the second drive member includes a plurality of second permanent magnets;
the plurality of first permanent magnets are arranged in sequence, and the plurality of second permanent magnets are arranged in sequence along a moving direction of the moving member relative to the opening;
at the first position and the second position, the second permanent magnets generate a first force with the first permanent magnets; and
at the third position, the second permanent magnets generate a second force with the first permanent magnets or a third force smaller than the first force generated at the first position.

6. The sealing structure according to claim 5, wherein:
at the first position and the second position, the first force generated by the second permanent magnets and the first permanent magnets is a repulsive force; and
at the third position, the second force generated by the second permanent magnets and the first permanent magnets is an attractive force, or the third force generated by the second permanent magnets and the first permanent magnets is a repulsive force smaller than the repulsive force at the first position.

7. The sealing structure according to claim 5, wherein:
at least two first permanent magnets and at least two second permanent magnets are provided; and
in a direction of the moving member moving relative to the opening, a width of each first permanent magnet and a width of each second permanent magnet are same, and the width of the first permanent magnet is one third of a moving distance of the moving member relative to the opening.

8. The sealing structure according to claim 4, further comprising a support frame fixedly connected to the housing, an installation space being formed between the support frame and the housing, the moving member being arranged in the installation space, and the first drive member being fixed at the support frame.

9. The sealing structure according to claim 4, further comprising a sliding member, wherein:
the housing includes a sliding groove cooperating with the sliding member;
the sliding member is slidingly mounted in the sliding groove;
the moving member is fixed on a side of the moving member close to the opening; and
the second drive member is fixed on a side of the sliding member away from the opening.

10. An electronic device comprising:
a sealing structure including:
a housing including an opening;
a moving member located within a space enclosed by the housing and being capable of moving relative to the opening from a first position to a second position;
a sealing element arranged between the housing and the moving member; and
a drive assembly providing a first force to the moving member in a direction from the moving member to the opening at the first position and the second position to cause the sealing element to be abutted between the moving member and the housing to seal the opening; and
a toggle switch connected to the moving member.

11. The electronic device according to claim 10, wherein:
the moving member moves from the first position to the second position via a third position relative to the opening; and
at the third position, the drive assembly provides a second force having a direction opposite to the first force or a third force smaller than the first force when the moving member is at the first position to the moving member to cause a force of abutting the sealing element between the moving member and the housing to be reduced.

12. The electronic device according to claim 11, wherein:
an accommodation groove is formed on a side of the moving member facing the opening;
the sealing element is fixed in the accommodation groove; and
the sealing element moves with the moving member together relative to the opening.

13. The electronic device according to claim 11, wherein the drive assembly includes:
a first drive member mounted at the housing; and
a second drive member mounted at the moving member, the first drive member and the second drive member interact to generate a force.

14. The electronic device according to claim 13, wherein:
the first drive member includes a plurality of first permanent magnets, and/or the second drive member includes a plurality of second permanent magnets;
the plurality of first permanent magnets are arranged in sequence, and the plurality of second permanent magnets are arranged in sequence along a moving direction of the moving member relative to the opening;
at the first position and the second position, the second permanent magnets generate a first force with the first permanent magnets; and
at the third position, the second permanent magnets generate a second force with the first permanent magnets or a third force smaller than the first force generated at the first position.

15. The electronic device according to claim 14, wherein:
at the first position and the second position, the first force generated by the second permanent magnets and the first permanent magnets is a repulsive force; and
at the third position, the second force generated by the second permanent magnets and the first permanent magnets is an attractive force, or the third force generated by the second permanent magnets and the first permanent magnets is a repulsive force smaller than the repulsive force at the first position.

16. The electronic device according to claim 14, wherein:
at least two first permanent magnets and at least two second permanent magnets are provided; and
in a direction of the moving member moving relative to the opening, a width of each first permanent magnet and a width of each second permanent magnet are same, and the width of the first permanent magnet is one third of a moving distance of the moving member relative to the opening.

17. The electronic device according to claim 13, further comprising a support frame fixedly connected to the housing, an installation space being formed between the support frame and the housing, the moving member being arranged in the installation space, and the first drive member being fixed at the support frame.

18. The electronic device according to claim 13, further comprising a sliding member, wherein:
the housing includes a sliding groove cooperating with the sliding member;
the sliding member is slidingly mounted in the sliding groove;
the moving member is fixed on a side of the moving member close to the opening; and
the second drive member is fixed on a side of the sliding member away from the opening.
